(19) United States
(12) Patent Application Publication
(10) Pub. No.: US 2010/0234051 A1
(43) Pub. Date: Sep. 16, 2010

(54) ACCESSORY TRANSCEIVER FOR MOBILE DEVICES

(75) Inventors: Paul Holden, San Francisco, CA (US); Robert E. Borchers, Pleasanton, CA (US); Jesse Dorogusker, Palo Alto, CA (US); Emily Clark Schubert, San Jose, CA (US); Stephen Chick, Mountain View, CA (US)

Correspondence Address: TOWNSEND AND TOWNSEND AND CREW, LLP, TWO EMBARCADERO CENTER, 8TH FLOOR, SAN FRANCISCO, CA, 94111-3834, US

(73) Assignee: Apple Inc., Cupertino, CA (US)

(21) Appl. No.: 12/725,301

(22) Filed: Mar. 16, 2010

Related U.S. Application Data
(60) Provisional application No. 61/160,636, filed on Mar. 16, 2009.

(51) Int. Cl. H04W 4/12; H04M 1/00; H04B 1/40

(52) U.S. Cl. 455/466; 455/557; 455/88

(57) ABSTRACT

A mobile device can connect with a wired or wireless network through an accessory transceiver. In some embodiments, the mobile device can receive user input through the user interface and can connect with a network using the accessory transceiver. The mobile device and the accessory transceiver can be physically coupled together using a cable or other connector (e.g., USB connector), or the mobile device and the accessory transceiver can be wirelessly coupled together using a wireless protocol (e.g., Bluetooth, Wi-Fi). Moreover, in to connect with one network and can use an accessory transceiver to connect with a different network.

### CROSS-REFERENCES TO RELATED APPLICATIONS

This application is a non-provisional, and claims the benefit, of commonly assigned U.S. Provisional Patent Application No. 61/160,636, filed on Mar. 16, 2009, entitled “Wireless Transceiver Accessory For Mobile Device,” the entirety of which is herein incorporated by reference for all purposes.

### BACKGROUND

Conventional mobile devices are often dedicated to performing a specific application. For example, a mobile phone provides telephony services; a personal digital assistant (PDA) provides a way to organize addresses, contacts, and notes; a media player plays content; a smart phone can provide email and/or web browsing applications; etc. Modern mobile devices often can incorporate many of these applications in a single device.

### SUMMARY

In some embodiments of the invention, an accessory transceiver can be used with a mobile device to either provide or enhance wireless communication capabilities provided by the mobile device and/or to use a different communication network, channel, or technology whether wired or wireless than provided by the mobile device.”

In some embodiments of the invention, a mobile device having an operating system and a user interface can be communicatively coupled with an accessory transceiver for connecting with a wireless network. The mobile device can receive user input through the user interface and can send commands and/or data to the accessory transceiver. Responsive to the commands, the accessory transceiver can initiate a communication session with a recipient device over a wireless network, and data can be communicated. Various wireless networks can be accessed such as, for example, a mobile telephone network, a WiFi network, a WiMax network, a satellite network, etc. The mobile device and the accessory transceiver can be physically coupled together using a cable or other connector (e.g., USB connector). In other implementations, the mobile device and the accessory transceiver can be wirelessly coupled together using a wireless protocol (e.g., Bluetooth, Wi-Fi).

An accessory transceiver that can provide a mobile device access to a mobile telephone network is also disclosed according to another embodiment of the invention. The accessory transceiver can be connected with the mobile device with either a physical connection or a wireless connection. In some embodiments, the mobile device can also include an internal wireless transceiver that can provide access to a different mobile telephone network. Thus, using the accessory transceiver can allow the mobile device to access two separate mobile telephone networks.

In other embodiments, an accessory transceiver can provide access to wireless networks other than a telephonic network, for example, satellite networks, a WiFi network, etc. Moreover, the accessory transceiver can also be used to send text messages, SMS messages, emails, web packets, etc.

### BRIEF DESCRIPTION OF THE DRAWINGS

FIG. 1 illustrates a mobile device according to some embodiments of the invention.

FIG. 2A shows a mobile device coupled with an accessory transceiver according to some embodiments of the invention.

FIG. 2B shows an accessory transceiver wirelessly coupled with a mobile device according to some embodiments of the invention.

FIGS. 3A and 3B are block diagrams of network operating environments for a mobile device according to some embodiments of the invention.

FIG. 4 is a block diagram of a mobile device architecture according to some embodiments of the invention.

FIG. 5 shows a block diagram of a mobile device coupled with an accessory transceiver according to one embodiment according to some embodiments of the invention.

FIG. 6 is a flow diagram of a process performed by the mobile device for communicating call requests and other information to an accessory transceiver.

FIG. 7 is a flow diagram of a process performed an accessory transceiver for receiving call requests and other information from a mobile device according to some embodiments of the invention.

FIG. 8 is a flow diagram of a process performed by an accessory transceiver to establish and maintain a telephone call according to some embodiments of the invention.

FIG. 9 is another flow diagram of a process performed by an accessory transceiver to establish and maintain a telephone call according to some embodiments of the invention.

### DETAILED DESCRIPTION

Embodiments of the present invention provide an accessory transceiver that can be communicatively coupled with a mobile device and can connect with a wireless network. Once connected with the wireless network, the mobile device can communicate with a third-party device through the wireless network. During operation, the accessory transceiver can receive data and/or commands for connecting with the wireless network. Once a communication channel has been established, data can be transmitted to and/or from the mobile device to the wireless network using the accessory transceiver. In some embodiments, the mobile device can have its own transceiver for communicating with a different wireless network. The wireless networks can be any type of wireless network. Thus, by using the accessory transceiver, the mobile device can connect with a wireless network that it may not otherwise be compatible with.

While some embodiments of the invention describe an accessory transceiver that can be used to communicate with a wireless network, a wired accessory transceiver can also be used. A wired accessory transceiver, for example, can be used to connect the mobile device to a wired network such as an Ethernet network, a DSL network, or a cable network.

For example, a mobile device can be equipped with an internal transceiver that allows the mobile device to communicate with a mobile phone network, for example, a GSM mobile telephone network. Telephone calls and/or text messages can be sent and/or received over this network. Because mobile telephone network quality and contract plans can vary, using embodiments of the invention, a user can use an accessory transceiver to communicate with a different mobile phone network, for example, a CDMA mobile telephone network. Such an accessory transceiver can allow users to conduct a mobile telephone call using an unauthorized network or on networks using a different communication protocol. Similar schemes can be used to connect with other network resources in addition to or instead of telephone resources.

Mobile Device

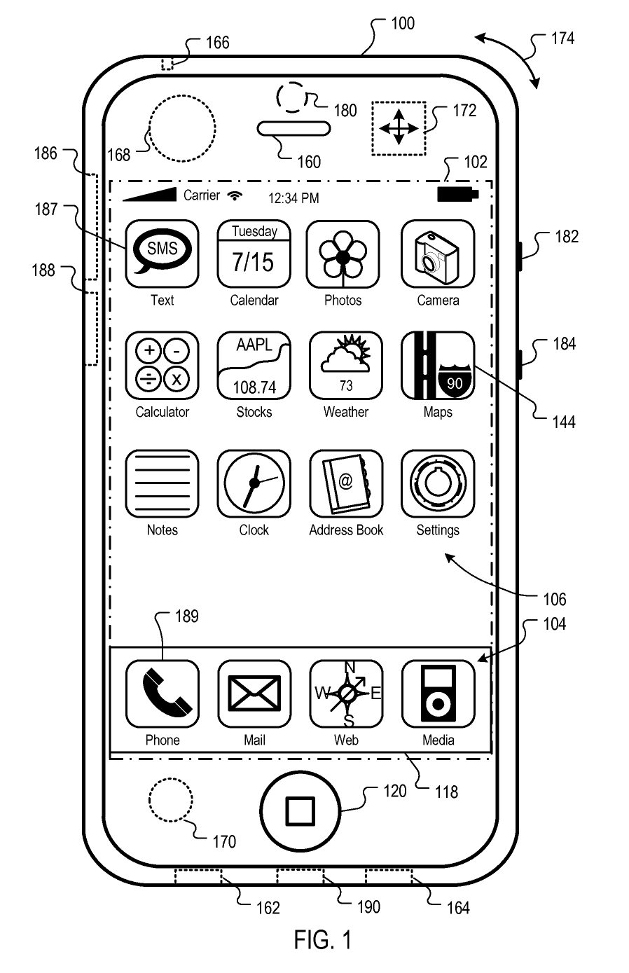

Various mobiles device can be used with embodiments described herein. FIG. 1 is a block diagram of an example of a mobile device. Mobile device 100 can be, for example, a handheld computer, a personal digital assistant, a cellular telephone, a network appliance, a camera, a smart phone, an enhanced general packet radio service (EGPRS) mobile phone, a network base station, a media player, a navigation device, an email device, a game console, a web browser, or a combination of any two or more of these data processing devices or other data processing devices.

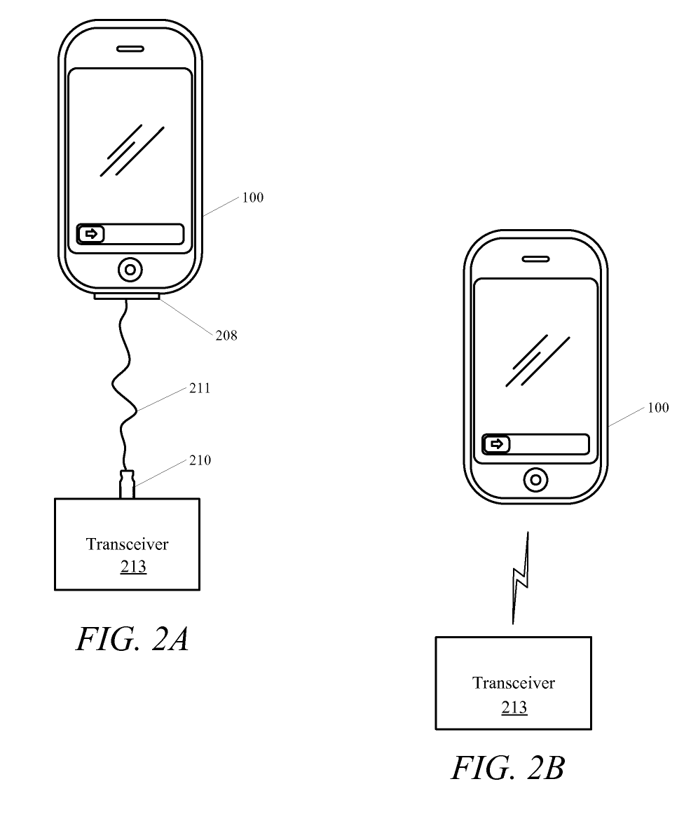

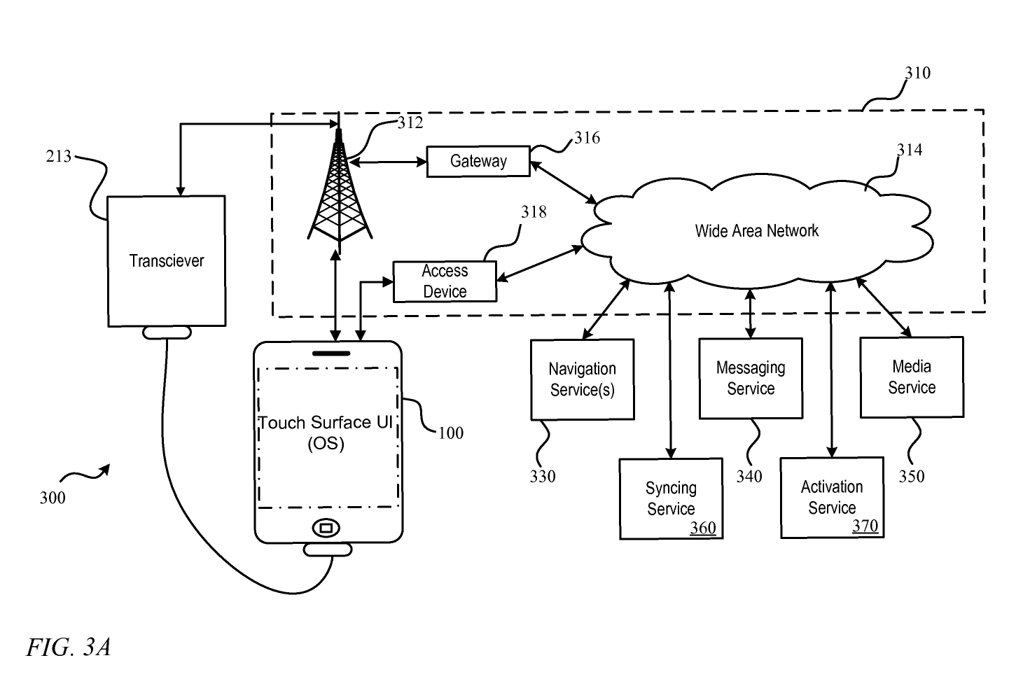

Mobile device 100 can be coupled with an accessory transceiver as shown in FIGS. 2A and 2B. FIG. 2A shows mobile device 100 coupled with accessory transceiver 213 using cable 211. Cable 211 can include connector 208 to connect with mobile device 100 and connector 210 to connect with accessory transceiver 213. FIG. 2B shows accessory transceiver 213 wirelessly coupled with mobile device 100 using for example, Bluetooth or WiFi.

The mobile device shown in FIGS. 2A and 2B, can be any type of mobile computing and/or communication device without limitation. For example, an iPod Touch™, an iPhone™, an Android compatible device and/or a Blackberry device can be used. Moreover, mobile device 100 can provide media player capability, networking, web browsing, email, word processing, data storage, application execution, and/or any other computing or communication functions.

Accessory transceiver 213 can be any device capable of communicating with a wireless network. Accessory transceiver 213 can be configured with circuitry to communicate with a mobile phone network, a WiFi network, a WiMax network, a satellite network, etc.

Mobile Device Overview

Returning to FIG. 1, in some implementations, mobile device 100 can include a touch-sensitive display 102 or surface. Touch-sensitive display 102 can implement liquid crystal display (LCD) technology, light emitting polymer display (LPD) technology, or some other display technology. The touch sensitive display 102 can be sensitive to haptic and/or tactile contact with a user.

In some implementations, touch-sensitive display 102 can comprise a multi touch sensitive display 102. A multi-touch-sensitive display 102 can, for example, process multiple simultaneous touch points, including processing data related to the pressure, degree, and/or position of each touch point. Such processing facilitates gestures and interactions with multiple fingers, chording, and other interactions. Other touch-sensitive display technologies can also be used, e.g., a display in which contact can be made using a stylus or other pointing device.

In some implementations, mobile device 100 can display one or more graphical user interfaces on touch-sensitive display 102 for providing the user access to various system objects and for conveying information to the user. In some implementations, the graphical user interface can include one or more display objects 104, 106. In the example shown, the display objects 104, 106, are graphic representations of system objects. Some examples of system objects include device functions, applications, windows, files, alerts, events, or other identifiable system objects.

Mobile Device Functionality

In some embodiments, mobile device 100 can implement multiple device functionalities such as, for example, a telephony device, an e-mail device, a network data communication device, a Wi-Fi base station device (not shown), and a media processing device. In some implementations, particular display objects 104 can be displayed in a menu bar 118. In some implementations, device functionalities can be accessed from a top-level graphical user interface, such as the graphical user interface illustrated in FIG. 1. Touching one of the display objects 104 can, for example, invoke corresponding functionality. For example, touching the display object 189 would invoke a telephony application on mobile device 100 for initiating a call with a recipient device.

In some implementations, mobile device 100 can implement network distribution functionality. For example, the functionality can enable the user to take mobile device 100 and provide access to its associated network while traveling. In particular, mobile device 100 can extend Internet access (e.g., Bluetooth, Wi-Fi) to other wireless devices in the vicinity. For example, mobile device 100 can be configured as a base station for one or more devices. As such, mobile device 100 can grant or deny network access to other wireless devices.

In some implementations, upon invocation of device functionality, the graphical user interface of mobile device 100 changes, or is augmented or replaced with another user interface or user interface elements, to facilitate user access to particular functions associated with the corresponding device functionality. For example, in response to a user touching a phone object, the graphical user interface of touch-sensitive display 102 may present display objects related to various phone functions; likewise, touching of an email object may cause the graphical user interface to present display objects related to various e mail functions; touching a Web object may cause the graphical user interface to present display objects related to various web-browsing functions; and touching a media player object may cause the graphical user interface to present display objects related to various media processing functions.

In some implementations, the top-level graphical user interface environment or state of FIG. 1 can be restored by pressing a button 120 located near the bottom of the mobile device 100. In some implementations, each corresponding device functionality may have corresponding “home” display objects displayed on the touch-sensitive display 102, and the top-level graphical user interface environment of FIG. 1 can be restored by pressing the “home” display object.

In some implementations, the top-level graphical user interface can include additional display objects 106, such as a short messaging service (SMS) object 187, a calendar object, a photos object, a camera object, a calculator object, a stocks object, a weather object, a maps object 144, a notes object, a clock object, an address book object, and a settings object. Touching the maps object 144 can, for example, invoke a mapping and location based services environment and supporting functionality; likewise, a selection of any of the display objects 106 can invoke a corresponding object environment and functionality.

Additional and/or different display objects can also be displayed in the graphical user interface of FIG. 1. For example, if the device 100 is functioning as a base station for other devices, one or more “connection” objects may appear in the graphical user interface to indicate the connection. In some implementations, the display objects 106 can be configured by a user, e.g., a user may specify which display objects 106 are displayed, and/or may download additional applications or other software that provides other functionalities and corresponding display objects.

In some implementations, mobile device 100 can include one or more input/output (I/O) devices and/or sensor devices. For example, a speaker 160 and a microphone 162 can be included to facilitate voice-enabled functionalities, such as phone and voice mail functions. In some implementations, an up/down button 184 for volume control of the speaker 160 and the microphone 162 can be included. Mobile device 100 can also include an on/off button 182 for a ring indicator of incoming phone calls. In some implementations, a loud speaker 164 can be included to facilitate hands-free voice functionalities, such as speaker phone functions. An audio jack 166 can also be included for use of headphones and/or a microphone.

In some implementations, a proximity sensor 168 can be included to facilitate the detection of the user positioning mobile device 100 proximate to the user's ear and, in response, to disengage touch-sensitive display 102 to prevent accidental function invocations. In some implementations, touch-sensitive display 102 can be turned off to conserve additional power when mobile device 100 is proximate to the user's ear.

Other sensors can also be used. For example, in some implementations, an ambient light sensor 170 can be utilized to facilitate adjusting the brightness of the touch sensitive display 102. In some implementations, an accelerometer 172 can be utilized to detect movement of the mobile device 100, as indicated by the directional arrow 174. Accordingly, display objects and/or media can be presented according to a detected orientation, e.g., portrait or landscape. In some implementations, mobile device 100 may include circuitry and sensors for supporting a location determining capability, such as that provided by the Global Positioning System (GPS) or other positioning systems (e.g., systems using Wi-Fi access points, television signals, cellular grids, Uniform Resource Locators (URLs)). In some implementations, a positioning system (e.g., a GPS receiver) can be integrated into mobile device 100 or provided as a separate device that can be coupled to mobile device 100 through an interface (e.g., port device 190) to provide access to location-based services.

In some implementations, a port device 190, e.g., a Universal Serial Bus (USB) port, or a docking port, or some other wired port connection, can be included. The port device 190 can, for example, be utilized to establish a wired connection to other computing devices, such as an accessory transceiver, network access devices, a personal computer, a printer, a display screen, or other processing devices capable of receiving and/or transmitting data. In some implementations, the port device 190 allows mobile device 100 to synchronize with a host device using one or more protocols, such as, for example, the TCP/IP, HTTP, UDP and any other known protocol.

Mobile device 100 can also include a camera lens and sensor 180. In some implementations, the camera lens and sensor 180 can be located on the back surface of the mobile device 100. The camera can capture still images and/or video.

Mobile device 100 can also include one or more wireless communication subsystems, such as an 802.11b/g communication device 186, and/or a Bluetooth™ communication device 188. Other communication protocols can also be supported, including other 802.x communication protocols (e.g., WiMax, Wi-Fi, 3G), code division multiple access (CDMA), global system for mobile communications (GSM), Enhanced Data GSM Environment (EDGE), etc.

Network Operating Environment

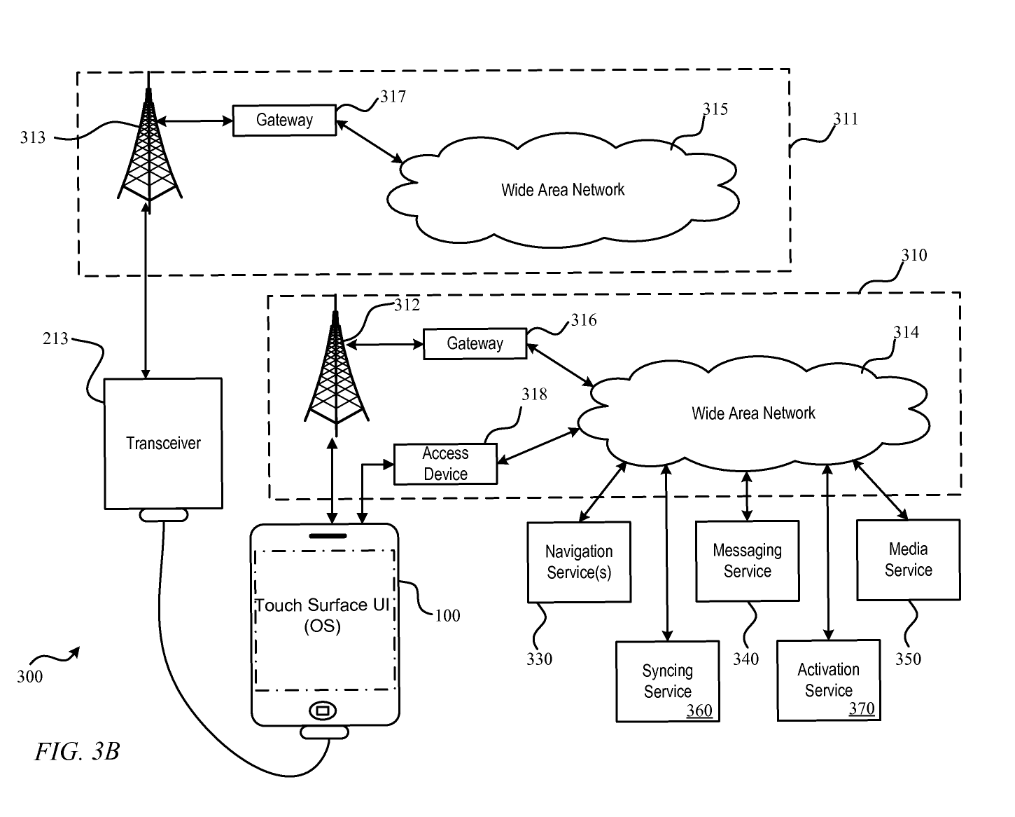

FIG. 3A is a block diagram of a network operating environment for the mobile device of FIG. 1. According to some embodiments, mobile device 100 and accessory transceiver 213 can, for example, both communicate over one or more wired and/or wireless communication environment 310 in data communication. For example, a wireless network 312, e.g., a cellular network, can communicate with a wide area network (WAN) 314, such as the Internet, by use of a gateway 316. Likewise, an access device 318, such as an 802.11g wireless access device, can provide communication access to the wide area network 314. In some implementations, both voice and data communications can be established over the wireless communication environment 310 and the access device 318. For example, mobile device 100 can place and receive phone calls (e.g., using VoIP protocols), send and receive e-mail messages (e.g., using POP3 protocol), and retrieve electronic documents and/or streams, such as web pages, photographs, and videos, over the wireless communication environment 310, gateway 316, and wide area network 314 (e.g., using TCP/IP or UDP protocols). Likewise, in some implementations, the mobile device 100 can place and receive phone calls, send and receive e-mail messages, and retrieve electronic documents over the access device 318 and the wide area network 314. In some implementations, mobile device 100 can be physically connected to the access device 318 using one or more cables and the access device 318 can be a personal computer. In this configuration, mobile device 100 can be referred to as a “tethered” device.

Mobile device 100 can also establish communications in other ways. For example, mobile device 100 can communicate with other wireless devices, e.g., other mobile devices 100, cell phones, etc., over the wireless network 312. Likewise, mobile device 100 can establish peer-to-peer communications, for example, a personal area network, by use of one or more communication subsystems, such as the Bluetooth™ communication devices 188 shown in FIG. 1. Other communication protocols, networks, and/or topologies can also be implemented.

Mobile device 100 can, for example, communicate with one or more services 330, 340, 350, 360, and 370 over the one or more wired and/or wireless networks 310. For example, one or more navigation services 330 can provide navigation information, e.g., map information, location information, route information, and other information, to the mobile device 100. A user of mobile device 100 can invoke a map functionality, e.g., by pressing the maps object 144 on the top-level graphical user interface shown in FIG. 1, and can request and receive a map for a particular location, request and receive route directions, or request and receive listings of businesses in the vicinity of a particular location, for example.

A messaging service 340 can, for example, provide e-mail and/or other messaging services. A media service 350 can, for example, provide access to media files, such as song files, audio books, movie files, video clips, and other media data. In some implementations, separate audio and video services (not shown) can provide access to the respective types of media files. A syncing service 360 can, for example, perform syncing services (e.g., sync files). An activation service 370 can, for example, perform an activation process for activating the mobile device 100. Other services can also be provided, including a software update service that automatically determines whether software updates exist for software on the mobile device 100, then downloads the software updates to mobile device 100 where the software updates can be manually or automatically unpacked and/or installed.

Mobile device 100 can also access other data and content over the one or more wired and/or wireless networks 310. For example, content publishers, such as news sites, RSS feeds, web sites, blogs, social networking sites, developer networks, etc., can be accessed by the mobile device 100. Such access can be provided by invocation of a web browsing function or application (e.g., a browser) in response to a user touching, for example, a Web object.

FIG. 3A shows accessory transceiver 213 communicating with the same wireless communication environment 310 as the mobile device 100. FIG. 3B, on the other hand, shows accessory transceiver 213 communicating with a different wireless communication environment 311, which can include a different gateway 317, a different wide area network 315, and/or a different wireless network 313. In some embodiments, wide area network 315 can be the same wide area network as wide area network 314. Thus, accessory transceiver 213 can provide network access through a different access point, provider, network, etc. The difference between wireless communication environment 310 and wireless communication environment 311 can include differences in bandwidth, difference in protocol, differences in connection type, differences in access, differences in network ownership, differences in security, differences in usage rates, differences in network quality, differences in service, differences in service provider, etc.

Mobile Device Architecture

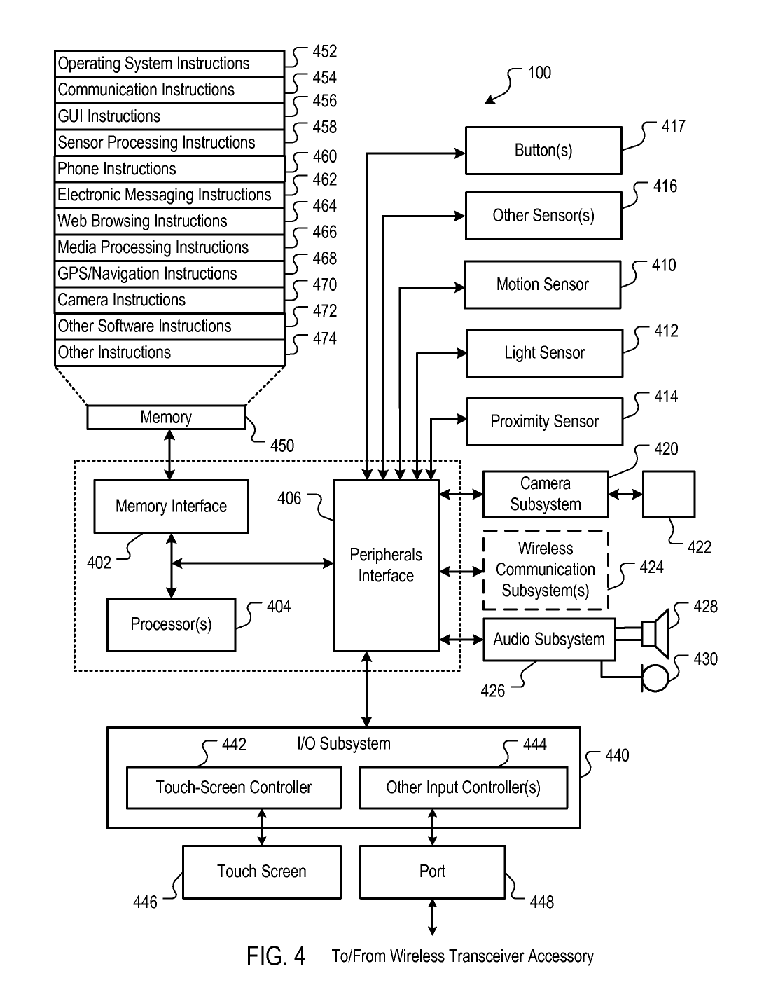

FIG. 4 is a block diagram of an architecture for mobile device 100 of FIG. 1. According to some embodiments, mobile device 100 can include a memory interface 402, one or more data processors, image processors and/or central processing units 404, and a peripherals interface 406. The memory interface 402, the one or more processors 404 and/or the peripherals interface 406 can be separate components or can be integrated in one or more integrated circuits. The various components in mobile device 100 can be coupled by one or more communication buses or signal lines.

Sensors, devices, and subsystems can be coupled to the peripherals interface 406 to facilitate multiple functionalities. For example, a motion sensor 410, a light sensor 412, and a proximity sensor 414 can be coupled to the peripherals interface 406 to facilitate the orientation, lighting, and proximity functions described with respect to FIG. 1. Other sensors 416 can also be connected to the peripherals interface 406, such as a positioning system (e.g., GPS receiver), a temperature sensor, a biometric sensor, or other sensing device, to facilitate related functionalities.

A camera subsystem 420 and an optical sensor 422, e.g., a charged coupled device (CCD) or a complementary metal-oxide semiconductor (CMOS) optical sensor, can be utilized to facilitate camera functions, such as recording photographs and video clips.

Communication functions can be facilitated through one or more wireless communication subsystems 424, which can include radio frequency receivers and transmitters and/or optical (e.g., infrared) receivers and transmitters. The specific design and implementation of the communication subsystem 424 can depend on the communication network(s) over which mobile device 100 is intended to operate. For example, a mobile device 100 may include communication subsystems 424 designed to operate over a GSM network, a GPRS network, an EDGE network, a Wi-Fi or WiMax network, and a Bluetooth™ network. In particular, the wireless communication subsystems 424 may include hosting protocols such that the device 100 may be configured as a base station for other wireless devices.

An audio subsystem 426 can be coupled to a speaker 428 and a microphone 430 to facilitate voice-enabled functions, such as voice recognition, voice replication, digital recording, and telephony functions.

The I/O subsystem 440 can include a touch screen controller 442 and/or other input controller(s) 444. The touch-screen controller 442 can be coupled to a touch screen 446. The touch screen 446 and touch screen controller 442 can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen 446.

The other input controller(s) 444 can be coupled to a port 448 (e.g., a pin connector), for coupling with accessories, such as the accessory transceiver 213, described in reference to FIG. 4.

In one implementation, a pressing of button 417 for a first duration may disengage a lock of the touch screen or surface 446; and a pressing of the button for a second duration that can be longer than the first duration may turn power to mobile device 100 on or off. The user may be able to customize a functionality of one or more of buttons 417. The touch screen 446 can, for example, also be used to implement virtual or soft buttons and/or a keyboard.

In some implementations, mobile device 100 can present recorded audio and/or video files, such as MP3, AAC, and MPEG files. In some implementations, mobile device 100 can include the functionality of an MP3 player, such as an iPod™. Mobile device 100 may, therefore, include a connector that can be compatible with the iPod. Other input/output and control devices can also be used.

The memory interface 402 can be coupled to memory 450. The memory 450 can include high-speed random access memory and/or non-volatile memory, such as one or more magnetic disk storage devices, one or more optical storage devices, and/or flash memory (e.g., NAND, NOR). The memory 450 can store an operating system 452, such as Darwin, RTXC, LINUX, UNIX, OS X, WINDOWS, or an embedded operating system such as VxWorks. The operating system 452 may include instructions for handling basic system services and for performing hardware dependent tasks. In some implementations, the operating system 452 can include a kernel (e.g., UNIX kernel).

The memory 450 may also store communication instructions 454 to facilitate communicating with one or more additional devices, one or more computers and/or one or more servers. The memory 450 may include graphical user interface instructions 456 to facilitate graphic user interface processing; sensor processing instructions 458 to facilitate sensor-related processing and functions; phone instructions 460 to facilitate phone-related processes and functions; electronic messaging instructions 462 to facilitate electronic-messaging related processes and functions; web browsing instructions 464 to facilitate web browsing-related processes and functions; media processing instructions 466 to facilitate media processing-related processes and functions; GPS/Navigation instructions 468 to facilitate GPS and navigation-related processes and instructions; camera instructions 470 to facilitate camera-related processes and functions; and/or other software instructions 472 to facilitate other processes and functions, e.g., security processes and functions. The memory 450 may also store other software instructions (not shown), such as web video instructions to facilitate web video-related processes and functions; and/or web shopping instructions to facilitate web shopping-related processes and functions. In some implementations, the media processing instructions 466 are divided into audio processing instructions and video processing instructions to facilitate audio processing-related processes and functions and video processing-related processes and functions, respectively. Other instructions 474 can be stored in memory 450, such as a framework or dynamic library.

Each of the above identified instructions and applications can correspond to a set of instructions for performing one or more functions described above. These instructions need not be implemented as separate software programs, procedures, or modules. The memory 450 can include additional instructions or fewer instructions. Furthermore, various functions of mobile device 100 may be implemented in hardware and/or in software, including in one or more signal processing and/or application specific integrated circuits.

Mobile Device and Accessory Transceiver Interaction

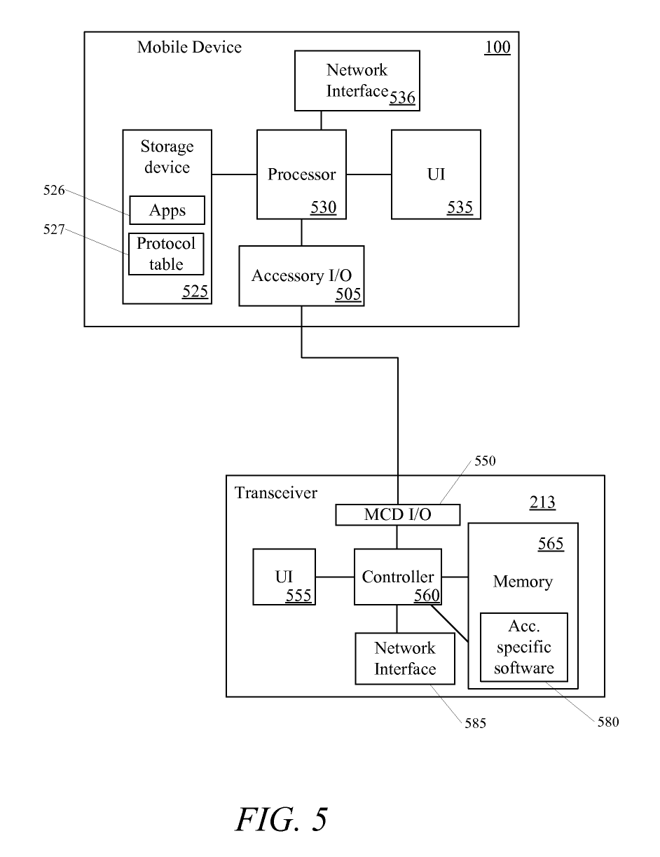

FIG. 5 shows a block diagram of mobile device 100 coupled with accessory transceiver 213 according to some embodiments. Mobile device 100 can include processor 530, storage device 525, user interface (UI) 535, network interface 536, and accessory input/output (I/O) interface 505.

Processor 530, which can be implemented as one or more integrated circuits (including, e.g., a conventional microprocessor or microcontroller), can control the operation of mobile device 100. For example, in response to user input signals provided by user interface 535, processor 506 can perform various tasks such as selecting and playing media assets that may be stored in stored in storage device 525; accessing various networks (e.g., a mobile telephone network, the Internet, local area network, or the like) to send and/or retrieve data using network interface 536; executing various application programs (Apps) 526 residing on storage device 525; and so on. Processor 530 can also manage communication with accessories via accessory I/O interface 505.

User interface 535 can include input controls such as a touch pad, touch screen, scroll wheel, click wheel, dial, button, keypad, microphone, etc., as well as output devices such as a display screen, indicator lights, speakers, headphone jacks, etc., together with supporting electronics (e.g., digital-to-analog or analog-to-digital converters, signal processors or the like). A user can operate the various input controls of user interface 535 to invoke the functionality of mobile device 100 and can also view and/or hear output from mobile device 100 via user interface 535.

Storage device 525 may be implemented, e.g., using disk, flash memory, or any other non-volatile storage medium. Storage device 525 can store application programs 526 that are executable by processor 530, system programs and other program code (not explicitly shown), and various data such as protocol table 527 that can be used in managing communication with various accessories, as described below. In some embodiments, storage device 525 can also store media assets such as audio, video, still images, or the like, that can be played by mobile communication device 100, along with metadata describing the media assets (e.g., asset name, artist, title, genre, etc.), playlists (lists of assets that can be played sequentially or in random order), and the like. Storage device 525 can also store any other type of information such as information about a user's contacts (names, addresses, phone numbers, etc.); scheduled appointments and events; notes; and/or other personal information.

Application programs (also referred to herein as “applications” or “apps”) 526 can include any program executable by processor 530. In some embodiments, certain applications can be installed on mobile device 100 by its manufacturer, while other applications can be installed by a user. Examples of application programs can include video game programs, personal information management programs, programs for playing media assets and/or navigating the media asset database, programs for controlling a telephone interface to place and/or receive calls, and so on. Certain application programs 526 may provide communication with and/or control of accessory transceiver 213, and certain application programs 526 may be responsive to control signals or other input from accessory transceiver 213; examples are described below.

Network interface 536 found in mobile device 100 can provide an interface to one or more communication networks. For example, network interface 536 can incorporate a radio-frequency (RF) transceiver and suitable components for communicating via a mobile communication network such as a mobile telephone network. Additionally or instead, network interface 536 can incorporate a wireless connection to the Internet (e.g., a WiFi transceiver, 3G transceiver, or the like), to a personal area network (e.g., a Bluetooth network), or any other network. In still other embodiments, a wired network connection (e.g., Ethernet) may be provided. In some embodiments, the same hardware can be used to support connections to multiple networks; thus, network interface 536 can include analog-to-digital and/or digital-to-analog circuitry, baseband processing components (e.g., codecs, channel estimators, and the like), modulators, demodulators, oscillators, amplifiers, transmitters, receivers, transceivers, internal and/or external antennas, and so on. In some embodiments, some operations associated with network connectivity can be implemented entirely or in part as programs executed on processor 530 (e.g., encoding, decoding, and/or other processing in the digital domain), or a dedicated digital signal processor can be provided.

Accessory I/O interface 505 can include a number of signal paths configured to carry various signals between mobile device 100 and accessory transceiver 213. In one embodiment, accessory I/O interface 505 includes a 30 pin connector corresponding to the connector used on iPod® and iPhone™ products manufactured and sold by Apple Inc.; other connectors can also be used. Alternatively or additionally, accessory I/O interface 505 can include a wireless interface (e.g., Bluetooth or the like).

In some embodiments, mobile device 100 can also use accessory I/O interface 505 to communicate with a host computer (not shown) that executes an asset management program that can provide media and/or applications for a mobile device (for example, iTunes® or Microsoft's application store). The asset management program can enable a user to add media assets and/or applications to mobile device and/or remove media assets from mobile device 100. The user can update metadata associated with media assets on mobile device 100. In some embodiments, the user can also interact with the asset management program to create and update playlists and/or applications as well as other documents. In one embodiment, the host computer maintains a master database of media assets and/or applications and can access other databases, for example, through the Internet (including associated metadata and playlists), and the asset management program synchronizes the master database with the database maintained on storage device 525 of mobile device 100 automatically whenever mobile device 100 connects to the host computer. In other embodiments, mobile device 100 can use network interface 536 to communicate with a host computer and/or directly with various other servers to acquire applications, media assets and/or other data.

Accessory transceiver 213 can include controller 560, user interface 555, mobile device I/O interface 550, network interface 585, and memory 565.

Mobile device I/O interface 550 can include a number of signal paths configured to carry various signals between accessory transceiver 213 and mobile device 100. In one embodiment, mobile device I/O interface 550 can include a connector adapted to mate with the 30-pin connector used on iPod® and iPhone™ products manufactured and sold by Apple Inc. Other connectors can also be used; for example, mobile device I/O interface 550 can include a standard USB or FireWire connector or the like. Alternatively or additionally, mobile device I/O interface 550 can include a wireless interface (e.g., Bluetooth or the like).

Controller 560 can include, e.g., a microprocessor or microcontroller executing program code to perform various functions such as digital audio decoding, analog or digital audio and/or video processing, processing of user input, controlling of accessory transceiver functionality and the like. Controller 560 can also manage communication with a mobile device via mobile device I/O interface 550.

User interface 555 can include input controls, such as a touch pad, touch screen, scroll wheel, click wheel, dial, button, keypad, microphone, probes, etc., as well as output devices, such as a video screen, indicator lights, speakers, headphone jacks or the like, together with supporting electronics (e.g., digital-to-analog or analog-to-digital converters, signal processors or the like). A user can operate the various input controls of user interface 555 to invoke the functionality of accessory transceiver 213 and can view and/or hear output from accessory transceiver 213 via user interface 555. In addition, in some embodiments, a user can operate mobile device 100 (or applications executing thereon) via accessory transceiver user interface 555.

Network interface 585 found in accessory transceiver 213 can provide an interface to one or more communication networks. For example, network interface 585 can incorporate a radio-frequency (RF) transceiver and suitable components for communicating via a mobile communication network such as a mobile telephone network. Additionally or instead, network interface 585 can incorporate a wireless connection to the Internet (e.g., a WiFi transceiver, 3G transceiver or the like), to a personal area network (e.g., a Bluetooth network), a satellite, or any other network. In still other embodiments, a wired network connection (e.g., Ethernet) may be provided. In some embodiments, the same hardware can be used to support connections to multiple networks; thus, network interface 585 can include analog-to-digital and/or digital-to-analog circuitry, baseband processing components (e.g., codecs, channel estimators, and the like), modulators, demodulators, oscillators, amplifiers, transmitters, receivers, transceivers, internal and/or external antennas, and so on. In some embodiments, some operations associated with network connectivity can be implemented entirely or in part as programs executed on processor 530 (e.g., encoding, decoding, and/or other processing in the digital domain), or a dedicated digital signal processor can be provided. In some embodiments, network interface 585 can include a telephone interface, GSM, CDMA, and/or other voice and/or data network interfaces.

Memory 565 can be implemented using any type of memory, disk, or other storage medium that can store program code for controller 560 and/or data. For example, memory 565 can store accessory transceiver specific software 580 that can provide instructions for controller 560 to interact with user interface 555. In some embodiments, accessory transceiver 213 can receive information (e.g., user input, metadata, and/or application data) from mobile device 100, and such information can also be stored in memory 565.

It will be appreciated that the system configurations and components described herein are illustrative and that variations and modifications are possible. The mobile device and/or accessory transceiver may have other capabilities not specifically described herein. While accessory transceiver 213 and mobile device 100 are described herein with reference to particular blocks, it is to be understood that the blocks are defined for convenience of description and are not intended to imply a particular physical arrangement of component parts. Further, the blocks need not correspond to physically distinct components.

Accessory I/O interface 505 of mobile device 100 and mobile device I/O interface 550 of accessory transceiver 213 allow mobile device 100 to be connected to accessory transceiver 213 and subsequently disconnected from accessory transceiver 213. As used herein, mobile device 100 and accessory transceiver 213 are “connected” whenever a communication channel between accessory I/O interface 505 and mobile device I/O interface 550 is open and are “disconnected” whenever the communication channel is closed. Connection can be achieved by physical attachment (e.g., between respective mating connectors of mobile device 100 and accessory transceiver 213), by an indirect attachment such as a cable, or by establishing a wireless communication channel. Similarly, disconnection can be achieved by physical detachment, disconnecting a cable, powering down accessory transceiver 213 or mobile device 100, or closing the wireless communication channel. Thus, a variety of communication channels may be used, including wired channels such as Universal Serial Bus (“USB”), FireWire (IEEE 1394 standard), or universal asynchronous receiver/transmitter (“UART”), or wireless channels such as Bluetooth (a short-range wireless communication standard developed by the Bluetooth SIG and licensed under the trademark Bluetooth®), WiFi (adhering to any of the IEEE 802.11 family standards), wireless personal area network, infrared, or the like. In some embodiments, communication can occur using both a wired and a wireless channel. In some embodiments, multiple communication channels between a mobile device and an accessory transceiver can be open concurrently, or a mobile device can be concurrently connected to multiple accessories, with each accessory using a different communication channel.

Regardless of the particular communication channel, as long as mobile device 100 and accessory transceiver 213 are connected to each other, the devices can communicate by exchanging commands and data as specified by an accessory communication protocol. The accessory communication protocol can define a format for sending messages between mobile device 100 and accessory transceiver 213. For instance, the accessory communication protocol may specify that each message can be sent in a packet with a header, a payload, and/or a tail. The header can provide basic information such as a start indicator, length of the packet, and a command to be processed by the recipient, while the payload provides any data associated with the command; the amount of associated data can be different for different commands, and some commands may provide for variable-length payloads. The packet can also include a tail that may provide error-detection or error-correction codes, e.g., as known in the art, and/or other information as desired. In various embodiments, the accessory communication protocol can define specific commands to indicate an action to be taken by the recipient; to signal completion of a task, change of state, or occurrence of an error; and/or to identify the nature of the associated data. In some embodiments, the commands may be defined such that any particular command can be valid in only one direction.

The accessory communication protocol can also specify one or more physical transport links usable for transmitting signals between devices. For example, the transport link can be a USB link, a UART link, a FireWire link, a Bluetooth link, a WiFi link, a parallel link, a serial link, etc. At this level, the accessory communication protocol can specify, e.g., start bytes, sync bytes, stop bytes, and/or other auxiliary signals. In some embodiments, the accessory communication protocol can provide for multiple alternative transport links; thus a single mobile device can support communication over a variety of physical links including wired and/or wireless links.

The accessory communication protocol can define a number of “lingoes,” where a “lingo” refers generally to a group of related commands that can be supported (or unsupported) by various classes of accessories. In one embodiment, a command can be uniquely identified by a first byte identifying the lingo to which the command belongs and a second byte identifying the particular command within the lingo. Other command structures may also be used. It is not required that all accessories, or all mobile devices to which an accessory transceiver can be connected, support every lingo defined within the accessory communication protocol or every command of a particular lingo (for instance, different devices might use different versions of a given lingo).

In some embodiments, every accessory transceiver 213 and every mobile device 100 that are designed to interoperate with each other support at least a “general” lingo that includes commands common to all such devices. The general lingo can include commands enabling the mobile device and the accessory transceiver to identify themselves to each other and to provide at least some information about their respective capabilities, including which (if any) other lingoes each supports and which capabilities of the other device each intends to use while connected.

The general lingo can also include authentication commands that the mobile device can use to verify the purported identity and capabilities of the accessory transceiver (or vice versa), and the accessory transceiver (or mobile computing device) may be blocked from invoking certain commands or lingoes if the authentication is unsuccessful. For example, an authentication manager (not shown) within mobile device 100 can communicate with an authentication controller (also not shown) within accessory transceiver 213 to perform an authentication procedure, e.g., based on public key cryptography and a store of digital certificates maintained within the authentication manager of mobile device 100.

The general lingo or another lingo of the accessory communication protocol can also include “tunnel” commands that allow an exchange of arbitrary information between an application 526 executing on mobile device 100 and accessory transceiver 213. For example, a TunnelToAcc command can be defined as being sendable by mobile device 100 to accessory transceiver 213. The payload of this command can be any data, control signals, or other information that an application 526 executing on mobile device 100 can generate and send to accessory transceiver 213. Similarly, a TunnelToHost command can be defined as being sendable by accessory transceiver 213 to mobile device 100. The payload of this command can be any data, control signals, or other information that accessory transceiver 213 can generate and send to an application 526 executing on mobile device 100. These tunnel commands can be defined such that the accessory communication protocol is agnostic as to the payload content. Examples of techniques for managing communication such that a particular application sends data, control signals or other information only to accessories capable of processing it (and vice versa) are described below.

In some embodiments, accessory transceiver 213 can communicate with an API associated with one or more applications at the mobile device using the application communication protocol. For example, such communication can use the “tunnel” command discussed above. In some embodiments, accessory transceiver 213 can communicate with an API associated with one or more application using accessory communication protocol. In other embodiments, accessory transceiver 213 can also communicate with the mobile device operating system using either or both of the accessory communication protocol and/or the application communication protocol. Thus, embodiments disclosed herein can be used to facilitate communication from the accessory transceiver 213 to an application, API, and/or an operating system at the mobile device using either or both of an application communication protocol and/or an accessory communication protocol.

An accessory communication protocol supported by a mobile device and an accessory transceiver can include various other lingoes, such as a simple remote lingo that allows an accessory transceiver to send a command indicating a function of the mobile device to be invoked, a remote user interface lingo that can be used to communicate commands and data related to replicating all or part of a user interface of the mobile device on the an accessory transceiver (thereby supporting a more advanced remote control), a communication lingo that allows a user, through the mobile device, to control wireless communication with the an accessory transceiver, a storage lingo that allows the an accessory transceiver to store data on the mobile computing device, and so on. Any lingo or combination of lingoes or other commands or groups of commands can be used in connection with embodiments described herein.

It will be appreciated that the accessory communication protocol described herein is illustrative and that variations and modifications are possible. Specific commands described herein can be replaced with other commands or combination of commands or other types of messages and formats. In addition, it is not required that all of the commands and operations described herein be supported by any particular mobile communication device or an accessory transceiver.

As noted above, application 526 executing on mobile device 100 and accessory transceiver 213 can exchange arbitrary data, control signals, and/or other information (also referred to herein as “messages”). These messages can relate to a wide variety of circumstances. For example, messages relating to user input events, detected external conditions, wireless network connectivity, data type, wireless communication protocol type, received data or any other events or conditions that may occur at mobile device 100 can be communicated to accessory transceiver 213. Conversely, messages relating to user input events, detected external conditions, received data or other events or conditions that may occur at accessory transceiver 213 can be communicated to mobile device 100.

In another example, accessory transceiver 213 can receive input events from mobile device 100 that correspond to user input and/or other data detected at mobile device 100, including but not limited to any of the data types described above. In some embodiments, such input events can be processed by controller 560 at accessory transceiver 213 to control network interface 585. For example, touch screen or other user input events at mobile device 100 can be sent to accessory transceiver 213 to control a connection with a network through network interface 585. Touch screen data, for example, can be sent in raw data format or as interpreted events (e.g., press, swipe, pinch). In some embodiments, accessory transceiver specific software 580 can include instructions to receive and/or interpret raw touch screen data. In some embodiments, accessory transceiver specific software 580 can include instructions to translate raw touch screen data into commands and/or controls for network interface 585. In another embodiment, the touch screen data can be provided in raw format to an application executing on mobile device 100, which can interpret the data and send corresponding commands and/or information to accessory transceiver 213.

Moreover, input events received at accessory transceiver 213 from mobile device 100 can be processed by controller 560 executing accessory transceiver specific software 580. In some embodiments, accessory transceiver specific software 580 can interact with accessory transceiver network interface 585 to control various aspects of a network connection.

Further, in some embodiments, network interface 585 can also be controlled by mobile device 100 via a connection with accessory transceiver 213. For example, an application executing on mobile device 100 can include program code that when executed by processor 530, can control, interface with, interoperate with, send signals to, stream data from, stream data to, and/or receive signals from the network interface 585 at accessory transceiver 213. In some embodiments, the application executing on mobile device 100 can exchange messages with a control program executing on controller 560 of accessory transceiver 213, thereby instructing controller 560 to communicate with and/or control operation of network interface 585. Such messages can be exchanged using an application protocol, e.g., as described below.

In some embodiments, an accessory transceiver and an application can exchange any messages desired, where the term “message” refers generally to any type of control signal, event, data, status or configuration information or any other type of information available to the sender. To facilitate exchange of messages, an accessory transceiver and an application can use a mutually agreed-upon application protocol. The application protocol can specify a universe of accepted formats for messages that can be exchanged. The accessory transceiver and the mobile device can structure the messages they send in accordance with the application protocol's universe of accepted formats and can interpret messages they receive in accordance with the application protocol's universe of accepted formats.

In certain embodiments described herein, application protocol messages can be sent to and from the accessory transceiver and the mobile device by encapsulating, wrapping, or packaging the messages within packets conforming to the accessory communication protocol, e.g., using tunneling commands as described above. Thus, the transport link specified by the accessory communication protocol can be used, and it is not necessary for an application protocol to specify a physical transport link.

### Various Embodiments

In some embodiments, the accessory transceiver can include a mobile telephone interface (e.g., network interface 585 can be a telephone interface). The mobile telephone interface can include circuitry for placing and receiving telephone calls. Various commands can be sent from the mobile device to the accessory transceiver that can be used to initiate a telephone call, notify the mobile device of a received call, send caller id information, end a call, initiate a call hold, initiate a conference call, initiate a hang up, receive a call, send a text message, send an SMS message, receive a text message, receive an SMS message, send an email, receive an email, send a web request, receive network data, etc. Various commands can be part of a general lingo or defined by a transceiver specific protocol (an accessory protocol) associated with the accessory transceiver.

In some embodiments, the mobile device can send a PlaceCall command to the accessory transceiver. The PlaceCall command can include at least a telephone number. Upon receipt the accessory transceiver can initiate a telephone call to the telephone number included in the command by connecting to a wireless telephone network. The PlaceCall command can also open an audio communication channel between the accessory transceiver and the mobile device that can stream audio between the two devices. When a telephone call has been connected a ConnectCall command can be sent from the accessory transceiver to the mobile device.

Various other commands can be used by mobile device 100. For example, an EndCall command can be sent by the mobile device to instruct the accessory transceiver to terminate the telephone call. A HoldCall command can be used by the mobile device to instruct the accessory transceiver to place the call on hold. An EndHoldCall command can be sent by the mobile device to instruct the accessory transceiver to take the phone call off of hold. In some embodiments, in response to commands from the mobile device the accessory transceiver can send return messages indicating the success or failure of implementing the commands.

A ConferenceCall command can be sent from the mobile device to the accessory transceiver that includes another phone number. Upon receipt the accessory transceiver can place the current call on hold and dial the other phone number that was included with the ConferenceCall command. A confirmation message can be sent to the mobile device when the second call has been established. A second or the same audio channel can be opened when the call is engaged. A MergeCall command can then be sent to merge the two phone calls. Any number of calls can be merged at one time.

Various commands can be used by the accessory transceiver. For example, a CallerID command can be used to send caller identification information to the mobile device. The command can include the telephone number and/or the name associated with the telephone number. A RecievedCall command can be sent to the mobile device when an incoming call is received by accessory transceiver. The RecievedCall command can include ring information and/or call identification information. In some embodiments, the mobile device can provide some indication to a user that a call has been received, for example, playing a ringtone, ringing, changing a display, etc.

In some embodiments, in response to a ReceivedCall command the mobile device can send a number of commands. Some commands can be initiated in response to an interaction between a user and the user interface of the mobile device. For example, a DeclineCall command can be sent to the accessory transceiver to instruct the accessory transceiver to decline the call, and the accessory transceiver can ignore the call. An AcceptCall command can be sent to instruct the accessory transceiver to answer the call, and a communication channel can be established.

In some embodiments, a user can interact directly with the accessory transceiver in order to place a telephone call. In such embodiments, for example, the accessory transceiver can initiate a telephone call. To do so, a user can simply provide the telephone number through a user interface at the accessory transceiver and the call can be placed. In other embodiments, the user can locate telephone numbers by accessing a contact list or database stored at the mobile device 213. To do so, in some embodiments, a RequestContactList command can be sent from the accessory transceiver to the mobile device. The RequestContactList command can include a text string that includes a name; an indication that the entire contact list be transferred; or an indication that contacts with specific features, identities, and/or starting letters in the name be sent to the accessory transceiver. In response, the mobile device can send a ContactList command that includes contact list information that can be displayed at the accessory transceiver and/or selectable by a user.

The accessory transceiver can also send and/or receive text messages and/or SMS messages. The following commands can be used with either text or SMS messages. In some embodiments, a SendTextMessage command can be sent from the mobile device to the accessory transceiver. The SendTextMessage command can include a text message identifier, a telephone number, a contact name, and/or a text message. Upon receipt, the accessory transceiver can send the text message to the provided telephone number and/or contact. If the text message is sent successfully a SuccessTextMessage command be sent back to the mobile device along with the text message identifier and/or the telephone number to indicate the text message was sent successfully. If the text message fails, a FailedTextMessage command be sent back to the mobile device along with the text message identifier and/or the telephone number to indicate the text message was not sent successfully. In some embodiments, separate commands can be used to send SMS text messages.

In some embodiments, a RecievedTextMessage command can be sent from the accessory transceiver to the mobile device in response to receiving a text message at the accessory transceiver. The RecievedTextMessage command can include the telephone number from where the text message was received, a contact name, and/or the text message. In some embodiments, separate commands can be used to send SMS text messages.

In some embodiments, an accessory transceiver can connect the mobile device with an Internet based network. For example, the network interface can connect with a network using any of the following protocols WiFi, a satellite protocol, WiMAX, 3G, 4G, or any other type of communication protocol. Various commands can be used to interact with the network. In some embodiments, a NetworkConnect command can be sent from the mobile device that instructs the accessory transceiver to connect to the network, regardless of the network type. A NetworkDisConnect command can be used to disconnect the accessory transceiver from the network. In other embodiments, the accessory transceiver can automatically connect with the network and can provide all network connectivity commands without instructions from the mobile device.

In some embodiments, data can be packetized at the mobile device and sent to the accessory transceiver to send on a wireless network. Similarly, packets can be received by the accessory transceiver and forwarded to the mobile device as packets. For example, a SendPacket command can be sent from the mobile device to the accessory transceiver that includes the packet to be sent as the payload. And a RecivedPacket command can be used to send a received packet from the accessory transceiver to the mobile device with the packets as the payload. In both case, a packet counter be included.

In some embodiments, data can be packetized and/or depacketized at the accessory transceiver. In such embodiments, the mobile device can send a SendData command to the accessory transceiver. The payload of the command can include the data to be sent or some of the data to be sent and the location where the data is to be sent. The accessory transceiver can then packetize the data according to the specific communication protocol implemented at the accessory transceiver. Similarly, the accessory transceiver can receive data and buffer the received data. Using a ReceivedData command, the accessory transceiver can send the data back to the mobile device. In such embodiments the packetization processing occurs at the accessory transceiver. Because various accessory transceivers may involve different network protocols, the accessory transceiver can be adapted for communication with a particular network using a specific network protocol. Indeed, in some embodiments, an accessory transceiver can include a transceiver that is designed to communicate with a single network, a singly type of network, or with a single network protocol. In other embodiments, an accessory transceiver can include one or more transceivers that can communicate with one or more networks, one or more network types, and/or with one or more network protocols. Thus, packetization can be performed at the accessory transceiver. However, in some embodiments, the mobile device may have more processing power and can execute an accessory transceiver specific packetization routine.

### Example Processes

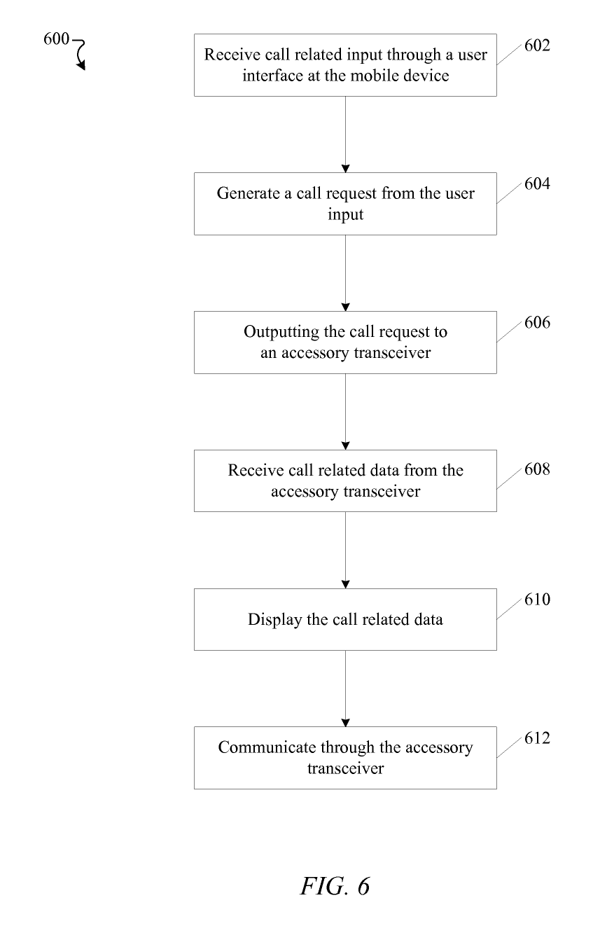

FIG. 6 is a flow diagram of process 600 that can be performed by the mobile device for communicating call requests and other information to an accessory transceiver according to some embodiments of the invention. In some embodiments, user input can be received through a user interface of the mobile device at block 602. The user input can be received, for example, through a touch input, a voice input, etc. The user input can indicate that a telephone call should be made by, for example, by dialing a phone number or selecting a phone number from a contact list. A call request (e.g., a PlaceCall command) can be generated based on the input at block 604. For example, one or more commands can be created by the processor of the first mobile device. The call request can include the telephone number. The call request can be sent to the accessory transceiver at block 606. For example, the one or more signals can be output to the accessory transceiver over a wired or wireless communication link. In some embodiments, call related data can be received at the mobile device from the accessory transceiver at block 608. Call related data can include, for example, phone number, caller id, caller name, call duration, call network, call fees, etc. The call related data can be displayed on the user interface of the mobile device at block 610 and the call can be maintained through the accessory transceiver at block 612. The telephone call can be maintained until discontinued by the mobile device, or an end call notification is received through the wireless network.

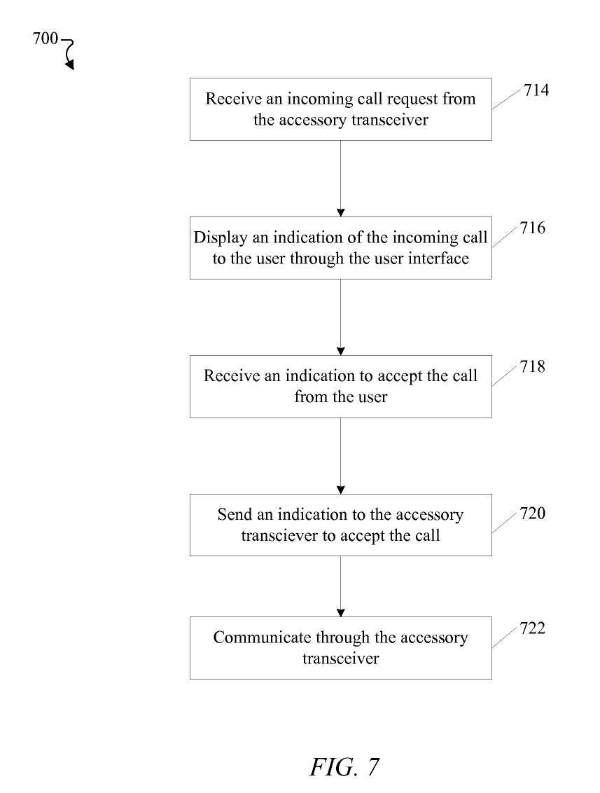

FIG. 7 is a flow diagram of process 700 performed by an accessory transceiver for receiving a call request from the network according to some embodiments of the invention. In some embodiments, a call request can be received at the accessory transceiver through the network. In response to the call request, at block 714, the accessory transceiver can send an incoming call request (e.g., a RecievedCall command) that indicates that a call has been received. The incoming call request can include caller id information. Responsive to the incoming call request, the mobile device can display information at the user interface that an incoming call has been received at block 716. This information can include changing the screen, playing a ring tone, vibrating, displaying caller id information, etc. In response, the user can choose to accept or decline the call at block 718. If the user chooses to accept the call, then an indication can be sent to the accessory transceiver at block 720. In response, the accessory transceiver can connect to the call and communication through the accessory transceiver can occur at block 722. The telephone call can be maintained until discontinued by the mobile device, or an end call notification is received through the wireless network.

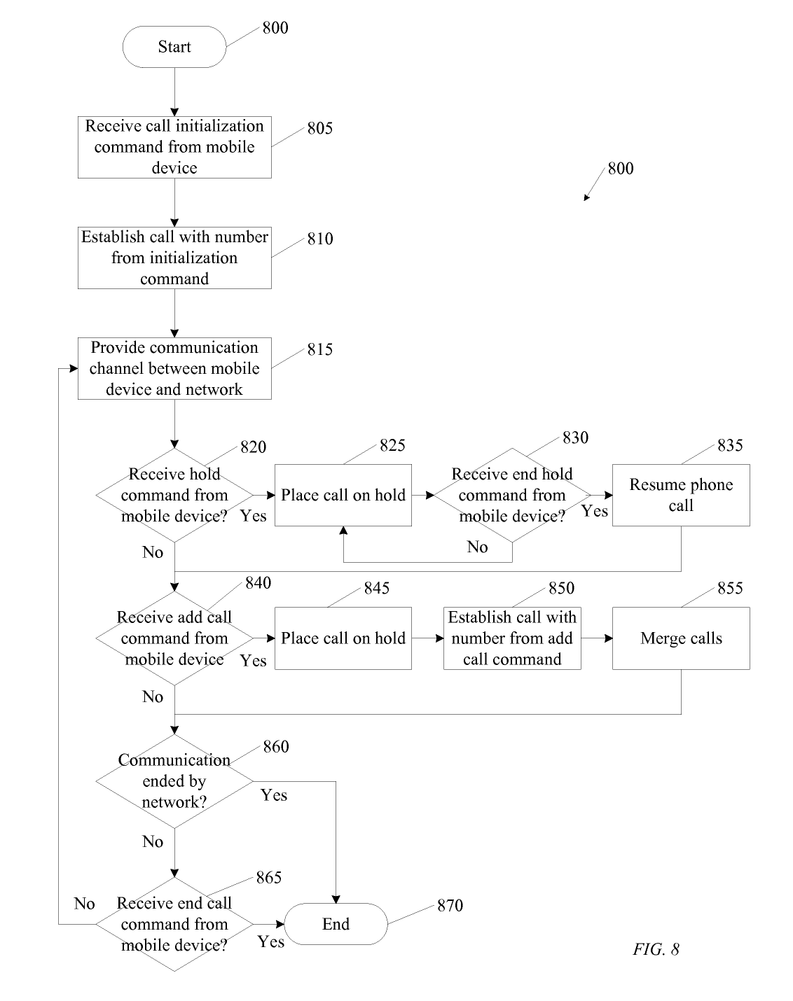

FIG. 8 shows a flow diagram of process 800 performed by an accessory transceiver according to some embodiments of the invention. Process 800 can start at block 805. At block 810 a call initiation command (e.g., PlaceCall) can be received by the accessory transceiver. The initiation command can include a phone number or a network address to be connected to through the accessory transceiver. A communication session (e.g., a telephone call) can be established at block 815 according to the parameters received in the initiation command. A communication channel can be established between the mobile device and the wireless network through the accessory transceiver. This channel can then connect a third party device to the mobile device through the accessory transceiver and the wireless network.

At block 820 if a hold call (e.g., HoldCall) command is received from the mobile device, then process 800 continues to block 825. The current call can then be placed on hold until a command is received from the mobile device that ends the hold at block 830. If an end hold command (e.g., EndHoldCall) is never received, the call may be terminated after some period of time set by the accessory transceiver, the network, and or the mobile device. When the end hold command is received, process 800 moves to block 835 and the phone call is resumed.

At block 840 and add call command (e.g., ConferenceCall) can be received from the mobile device. This command can include the phone number for a second call. At block 845 the current call is placed on hold, and at block 850 a second call can be established with the new phone number. At block 855 the calls can be merged. In some embodiments, the calls may not be merged (e.g., in response to a MergeCalls command sent from the mobile computing device). The second can be maintained until terminated while the first call remains on hold.

After block 855, process 800 can proceed to block 860. If the network ends the communication at block 860, then process 800 can end at block 870. The network can end the communication, for example, when the mobile device exits a coverage zone and/or when a user involved with the phone call terminates the call on their end.

At block, 865 if a command has been received from the mobile device to end the call, the phone call is terminated and process 800 ends at block 870. Otherwise, process 800 returns to block 815 and communication remains open.

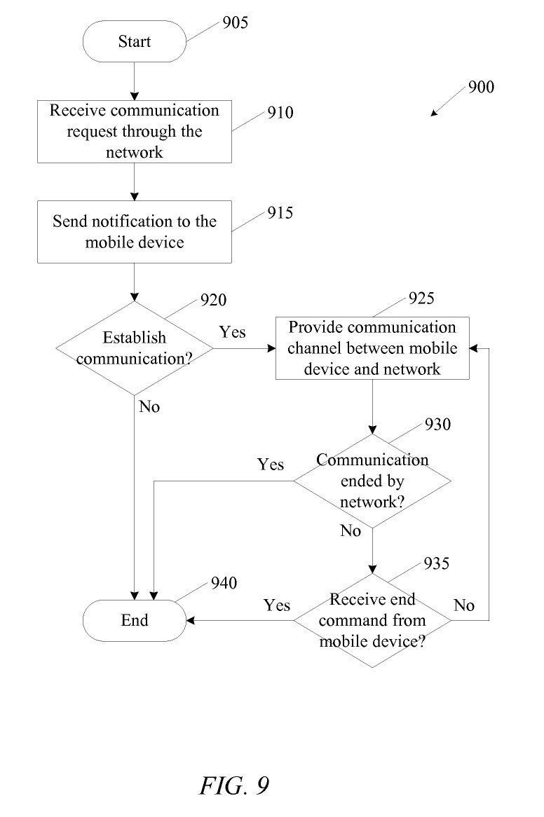

In some embodiments of the invention, a communication channel can be opened in response to a request received through the network, for example, a phone call received from another device through the network. FIG. 9 is another flow diagram of process 900 for performing such a process by an accessory transceiver. Process 900 starts at block 905. At block 910 a communication request can be received from the network. For example, another device may place a call to the number associated with the accessory transceiver, and the accessory transceiver may receive an incoming call notification from the network Various other connection requests can be made. At block 915 a notification can be sent to the mobile device. In some embodiments, in response to this notification or by command from the mobile device may change the screen, vibrate, or play a ring tone to indicate to the user a request has been made. The notification can also include information about the communication request such as, for example, a phone number associated with the device seeking communication, the network type, the communication type, the device name, the device type, etc.

In response to the notification sent to the mobile device, the user of the mobile device can chose to respond to the communication request. For example, the user can choose to accept the communication request. A command can be sent back to the accessory transceiver requesting communication to be established. At block 920 the accessory transceiver can decide whether to establish communication based on commands or inactivity from the mobile device. If, for example, the mobile device does not respond to the notification, the accessory transceiver can refuse to establish communication and process 900 can end at block 940. In other embodiments, a connection can be automatically established. In some embodiments, the mobile device can respond with a command that indicates whether to establish a communication channel through the network.

If the accessory transceiver has been instructed to establish communication, then a communication channel can be opened at block 925. At block 930, if the network or a device coupled with the network choose to end the communication, process 900 ends at block 940. Otherwise, process 900 proceeds to block 935. If the accessory transceiver receives a request to end the communication, then communication can be terminated and process 900 can end. If communication should be maintained then process 900 returns to block 925. Various other features can be includes such as call forwarding, voice mail, conference calling, text messaging, email, web browsing, call holding, server access for an application operating on the mobile device, etc.

The features described can be implemented in digital electronic circuitry, or in computer hardware, firmware, software, or in combinations of them. The features can be implemented in a computer program product tangibly embodied in an information carrier, e.g., in a machine-readable storage device or in a propagated signal, for execution by a programmable processor; and method steps can be performed by a programmable processor executing a program of instructions to perform functions of the described implementations by operating on input data and generating output.

The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language (e.g., Objective-C, Java), including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors or cores, of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network.

The computer system can include clients and servers. A client and server are generally remote from each other and typically interact through a network. The relationship of client and server arises by virtue of computer programs running on the respective computers and having a client-server relationship to each other.

A number of implementations have been described. Nevertheless, it will be understood that various modifications may be made. For example, elements of one or more implementations may be combined, deleted, modified, or supplemented to form further implementations. As yet another example, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

What is claimed is:

1. A system comprising:
a mobile device having an accessory interface; and
an accessory transceiver communicatively coupled to the mobile device through the accessory interface, the accessory transceiver having circuitry for establishing a network connection between the mobile device and a recipient device.

2. The system of claim 1, wherein the network connection is a telephone network connection.

3. The system of claim 1, wherein the mobile device is either wired or wirelessly coupled to the accessory transceiver.

4. The system of claim 1, further comprising an operating system, wherein at least a portion of the mobile devices functionality is accessible by the accessory transceiver device through an application programming interface.

5. The system of claim 4, wherein the API makes available to the accessory transceiver, data related to touch or gesture input on the touch surface.

6. The system of claim 1, wherein the accessory transceiver is another mobile device.

7. The method of claim 1, wherein the mobile device includes circuitry for establishing a call between the mobile device and a recipient device.

8. The method of claim 7, wherein the mobile device circuitry for establishing a call comprises circuitry for establishing the call through a network different from a network used by the accessory transceiver.

9. A computer-implemented method performed by an accessory transceiver communicatively coupled to a mobile device, the method comprising:
receiving signals indicative of an input through a user interface of the mobile device, the input indicative of a call request;
responsive to the signals, initiating connection with a wireless network using circuitry in the accessory transceiver;
receiving data from the wireless network; and
sending the data to the mobile device.

10. The method of claim 9, wherein the signals indicative of an input are received in response to a request made by the accessory transceiver through an Application Programming Interface (API) associated with an operating system running on the mobile device.

11. The method of claim 9, wherein the wireless network comprises a telephone network.

12. The method of claim 11, wherein the data comprises a text message.

13. The method of claim 9, further comprising:
receiving data from the mobile device; and
sending the data to the wireless network.

14. The method of claim 9, wherein the wireless network is different than a wireless network associated with the media device.

15. An accessory comprising:
a input/output port configured to couple with a mobile device and receive data and commands from the mobile device;
a transceiver configured to connect with a wireless network; and
a processor coupled with the transceiver and the input/output port, wherein the processor is configured to receive a connection request command from the mobile device through the input/output port, and in response to the connection request command, to establish a connection with a wireless network using the transceiver.

16. The accessory according to claim 15, wherein the processor is configured to send connection related data to the mobile device.

17. The accessory according to claim 15, wherein the processor is configured to send and receive data from the wireless network using the transceiver.

18. The accessory according to claim 15, wherein the wireless network is selected from the group consisting of a mobile telephone network, a WiFi network, a satellite network, and a WiMAX network.

19. An accessory comprising:
an input/output port configured to couple with a mobile device and receive data and commands from the mobile device;
a wireless transceiver configured to connect with a wireless network; and
a processor coupled with the wireless transceiver and the input/output port, wherein the processor is configured to:
receive a connection request from a third party device through the wireless transceiver over the wireless network;
notify the mobile device regarding the connection request through the input/output port;
receive an indication from the mobile device through the input/output port to establish communication with the third party device through the wireless network; and
establish communication with the third party device through the wireless network in response to the indication.

20. The accessory according to claim 19, wherein the wireless network is a CDMA network.

21. The accessory according to claim 19, wherein the connection request comprises an incoming telephone call.

22. A method operable at a mobile device, the method comprising:
communicating with a first wireless network; and
communicating with a second wireless network through an accessory device, wherein the second wireless network is different from the first wireless network.

23. The method according to claim 22, wherein the mobile device communicates with the accessory device using the first wireless network.

24. The method according to claim 22, wherein the either or both the first wireless network and the second wireless network are selected from the group consisting of a mobile telephone network, a WiFi network, a satellite network, and a WiMAX network.

25. The method according to claim 22, wherein the first wireless network comprises a first mobile telephone network and the second wireless network comprises a second mobile telephone network.
